(19) United States
(12) Patent Application Publication
(10) Pub. No.: US 2025/0308804 A1
(43) Pub. Date: Oct. 2, 2025

(54) CERAMIC ELECTRONIC DEVICE

(71) Applicant: TAIYO YUDEN CO., LTD., Tokyo (JP)

(72) Inventor: Yoichi KATO, Tokyo (JP)

(73) Assignee: TAIYO YUDEN CO., LTD., Tokyo (JP)

(21) Appl. No.: 19/087,862

(22) Filed: Mar. 24, 2025

(30) Foreign Application Priority Data
Mar. 29, 2024 (JP) 2024-056900

(51) Int. Cl. H01G 4/30; H01G 4/012; H01G 4/12

(52) U.S. Cl. CPC H01G 4/30; H01G 4/012; H01G 4/1227

(57) ABSTRACT

A ceramic electronic device includes a multilayer chip including a multilayer portion in which each of dielectric layers and each of internal electrode layers are alternately stacked. Each of the internal electrode layers is alternately extracted to two end faces of the multilayer chip opposite to each other. The multilayer chip includes side margins outside of a capacity section in a third direction which is orthogonal to a first direction in which the internal electrode layers face each other and a second direction in which the two end faces are opposite to each other. The capacity section is a section in which the internal electrode layers face each other. A number of the internal electrode layers is 300 or more. A thickness of one of the internal electrode layers is 1.5 times a thickness of one of the dielectric layers or more.

### CROSS-REFERENCE TO RELATED APPLICATION

This application is based upon and claims the benefit of priority of the prior Japanese Patent Application No. 2024-056900, filed on Mar. 29, 2024, the entire contents of which are incorporated herein by reference.

### FIELD

A certain aspect of the present disclosure relates to a ceramic electronic device.

### BACKGROUND

Ceramic electronic devices such as multilayer ceramic capacitors have a structure in which internal electrode layers are stacked with dielectric layers sandwiched between them (see, for example, Japanese Patent Application Publication No. 2014-204117, US Patent Application Publication No. 2022/0157530, and Japanese Patent Application Publication No. 2022-073955).

### SUMMARY OF THE INVENTION

According to an aspect of the embodiments, there is provided a ceramic electronic device including: a multilayer chip including a multilayer portion in which each of a plurality of dielectric layers and each of a plurality of internal electrode layers are alternately stacked, wherein each of the plurality of internal electrode layers is alternately extracted to two end faces of the multilayer chip opposite to each other, wherein the multilayer chip includes side margins outside of a capacity section in a third direction which is orthogonal to a first direction in which the plurality of internal electrode layers face each other and a second direction in which the two end faces are opposite to each other, the capacity section being a section in which the plurality of internal electrode layers face each other, wherein a number of the plurality of internal electrode layers is 300 or more, and wherein a thickness of one of the plurality of internal electrode layers is 1.5 times a thickness of one of the plurality of dielectric layers or more.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4 is an enlarged cross-sectional view of a vicinity of an external electrode;

FIG. 5A is an enlarged view of a YZ cross section;

FIG. 5B is an enlarged view of a XZ cross section;

FIG. 6 is a diagram for explaining grain rearrangement;

FIG. 7 is a schematic cross-sectional view illustrating an enlarged view of a vicinity of a side margin;

FIG. 8 is a diagram for explaining each region in a YZ cross section corresponding to a cross section of a line B-B in FIG. 1;

FIG. 9 is a diagram illustrating a relationship between an amount of silicon amount and an amount of shrinkage;

FIG. 10 illustrates a flow of a manufacturing method of a multilayer ceramic capacitor;

FIG. 11A and FIG. 11B illustrate a forming process of an internal electrode;

FIG. 12 illustrates a stacking process; and

FIG. 13 illustrates a case where a side margin is attached later.

### DETAILED DESCRIPTION

Generally, in a dielectric layer, the larger the grain diameter is, the higher the dielectric constant is, and the higher the dielectric constant is, the higher the electrostatic capacity of the entire ceramic electronic component is. However, in the low voltage and high frequency range, a high dielectric constant dielectric body may have its electrostatic capacity reversed by a low dielectric constant dielectric body.

Hereinafter, an exemplary embodiment will be described with reference to the accompanying drawings.

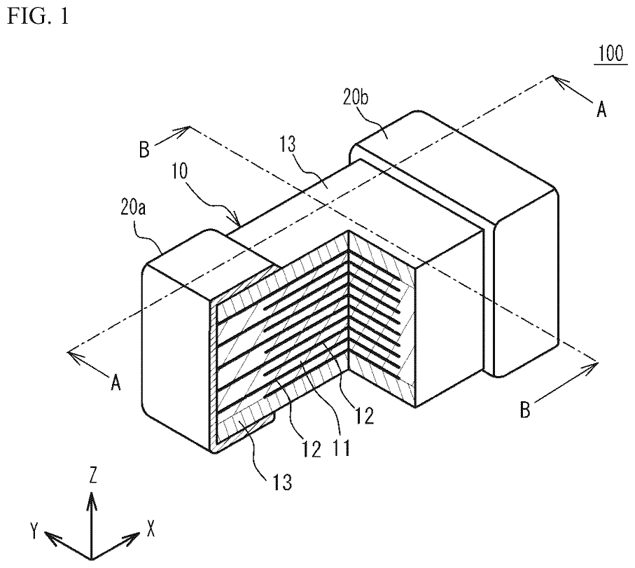

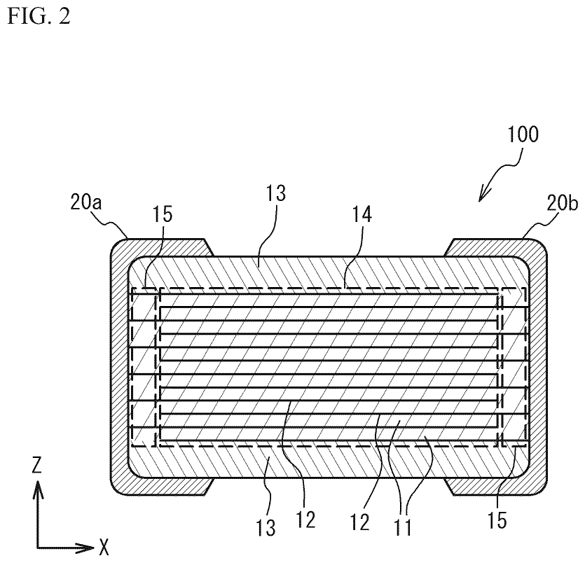

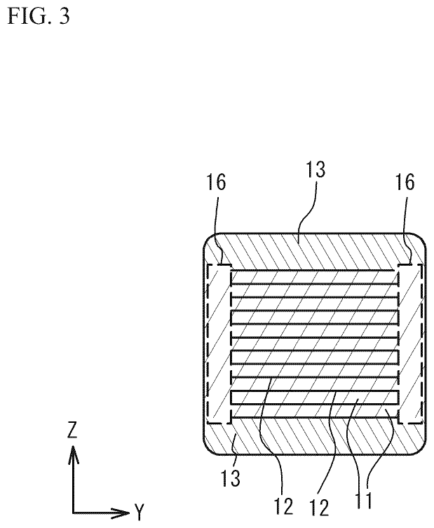

(Embodiment) FIG. 1 illustrates a perspective view of the multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the multilayer chip 10. The X-axis direction is a direction in which the two end faces of the multilayer chip 10 are opposite to each other and in which the external electrode 20a is opposite to the external electrode 20b. A Y-axis direction (third direction) is a width direction of the internal electrode layers. The Y-axis direction is a direction in which the two side faces of the multilayer chip 10 are opposite to each other. The X-axis direction, the Y-axis direction and the Z-axis direction are vertical to each other.

The multilayer chip 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The internal electrode layer 12 may include a ceramic grain such as a co-material.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr₂O₃ may be barium strontium titanate, barium calcium titanate, barium zirconate, barium titanate zirconate, calcium titanate zirconate, barium calcium titanate zirconate or the like. For example, the concentration of the main component ceramic material in the dielectric layer 11 is 90 at % or more.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the multilayer chip 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

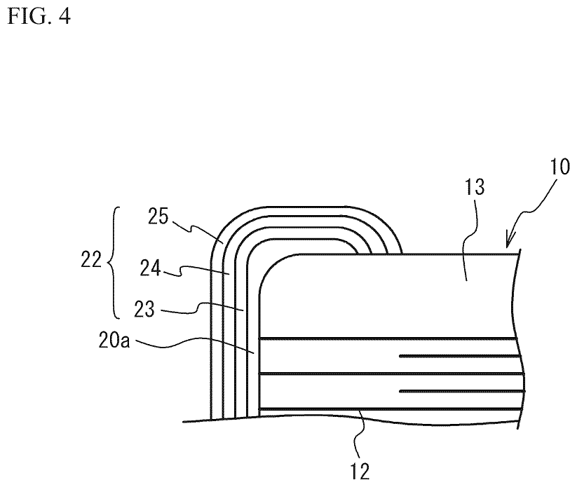

FIG. 4 is an enlarged cross-sectional view of the vicinity of the external electrode 20a. In FIG. 4, hatches are omitted. As illustrated in FIG. 4, a plated layer 22 may be provided on the outer surface of the external electrode 20a, using the external electrode 20a as a base layer. The external electrode 20a has Cu as a main component. The external electrode 20a may contain a glass component. The plated layer 22 mainly contains metals such as Cu, Ni, aluminum (Al), zinc (Zn), and Sn, or alloys of two or more of these metals. The plated layer 22 may be a plated layer of a single metal component, or may be a plurality of plated layers of mutually different metal components. For example, the plated layer 22 has a structure in which a first plated layer 23, a second plated layer 24, and a third plated layer 25 are formed in order from the external electrode 20a side. The first plated layer 23 is, for example, a Cu-plated layer. The second plated layer 24 is, for example, a Ni plated layer. The third plated layer 25 is, for example, a Sn-plated layer. Although FIG. 4 illustrates the external electrode 20a, the plated layer 22 may be similarly provided on the outer surface of the external electrode 20b.

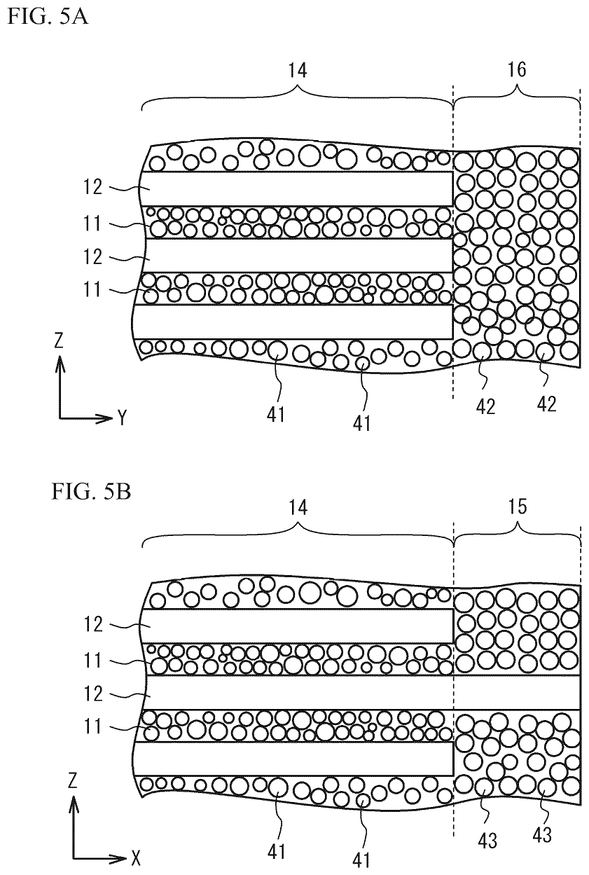

FIG. 5A is an enlarged view of the YZ cross section. As illustrated in FIG. 5A, the dielectric layer 11 has a structure in which a plurality of ceramic grains 41 are sintered. The side margin 16 has a structure in which a plurality of ceramic grains 42 are sintered. FIG. 5B is an enlarged view of the XZ cross section. As illustrated in FIG. 5B, the ceramic portion in the end margin 15 has a structure in which a plurality of ceramic grains 43 are sintered.

In such a multilayer ceramic capacitor, generally, the larger the grain diameter in the dielectric layer is, the higher the dielectric constant is, and the higher the dielectric constant is, the higher the electrostatic capacitor of the entire multilayer ceramic capacitor is. However, in the low-voltage and high-frequency range, a dielectric body with a high dielectric constant may have its electrostatic capacitor reversed by a dielectric body with a low dielectric constant.

Recently, there has been an increasing demand for multilayer ceramic capacitors to exhibit high electrostatic capacity in the low-voltage and high-frequency range. Accordingly, there is a demand for dielectrics and structural designs that are different from those used up until now.

In order to increase the electrostatic capacity in the low voltage and high frequency range, it is known that it is effective to increase the number of layers while keeping the grain diameter in the dielectric layer uniform and small, and to increase the area of the internal electrode layers inside the ceramic electronic device. Methods of increasing the number of layers include reducing the thickness of each layer or slightly expanding the case size in the height direction. In order to reduce the grain diameter, it is necessary to reduce the particle size of the dielectric material powder.

However, if a small-diameter dielectric material powder is used, grain rearrangement during sintering becomes easier, and sintering progresses more easily. As sintering progresses, the grain diameter gradually becomes larger. This tendency is particularly noticeable near the side margins and end margins, where the continuity of the electrodes is interrupted and grain rearrangement is more likely to occur.

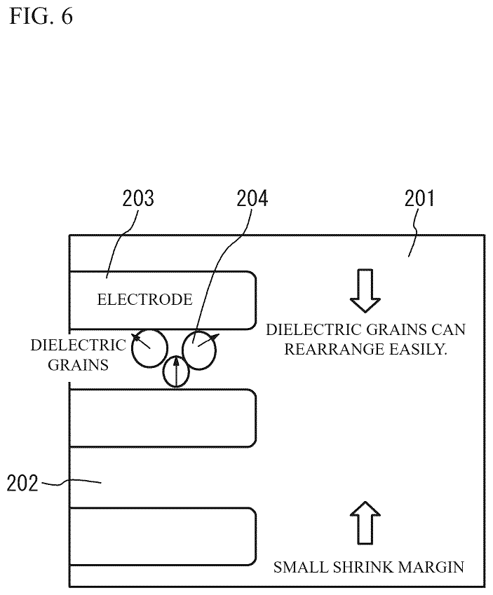

FIG. 6 is a diagram for explaining grain rearrangement. In FIG. 6, a cross section near the side margin 201 is drawn in a schematic manner. As illustrated in FIG. 6, when the dielectric layer 202 and the internal electrode layer 203 have the same thickness, the region of the internal electrode layer 203 in the Z-axis direction where sintering is likely to proceed first during firing becomes narrower, so the amount of shrinkage of the side margin 201 in the Z-axis direction becomes smaller. This makes it relatively easy to rearrange the ceramic grains 204 in the dielectric layer 202 region. Similarly, the amount of shrinkage in the end margin is also small, so that the rearrangement of the ceramic grains 204 in the dielectric layer 202 region becomes relatively easy.

Furthermore, the more the number of layers of the dielectric layer 202 and the internal electrode layer 203 increases, the more the restraining force from the side margin 201 is dispersed, and the more likely it is that rearrangement of the ceramic grains 204 will occur in the dielectric layer 202, and sintering will progress. Therefore, when a smaller-diameter dielectric material is used and the number of layers is increased, it is difficult to obtain the desired uniform grain distribution of small diameters.

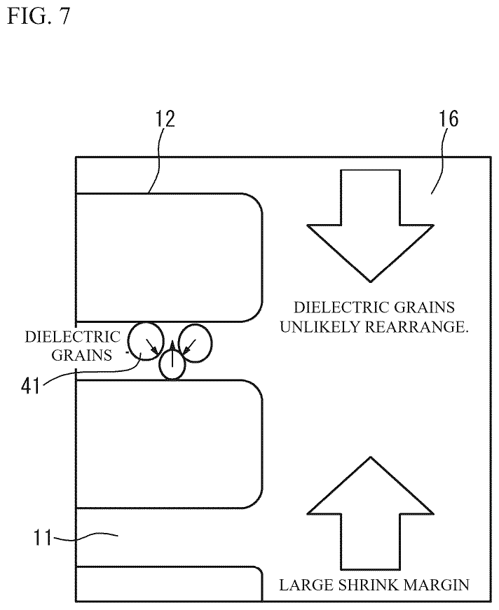

Therefore, the multilayer ceramic capacitor 100 according to this embodiment has a configuration that can suppress rearrangement of the ceramic grains 41 in the dielectric layers 11. First, the number of layers of the internal electrode layers 12 is set to 300 or more. This makes it possible to increase the electrostatic capacity. Next, the thickness of the internal electrode layers 12 in the Z-axis direction is increased. FIG. 7 is a schematic cross-sectional view illustrating an enlarged view of the vicinity of the side margin 16. As illustrated in FIG. 7, the thickness of the internal electrode layers 12 in the Z-axis direction is set to 1.5 times or more the thickness of each dielectric layer 11 in the Z-axis direction. In this configuration, the region of the internal electrode layers 203 in the Z-axis direction, where sintering is likely to proceed first during firing, becomes wider, so the amount of shrinkage of the side margins 16 in the Z-axis direction increases. As a result, a compressive stress in the Z-axis direction is applied in the region of the dielectric layer 11, the rearrangement of the ceramic grains 41 is suppressed, and the enlargement of the grain diameter in the dielectric layer 11 is suppressed, making it possible to reduce the diameter of the ceramic grains 41 and to make the grain diameter of the ceramic grains 41 uniform. As a result, the electrostatic capacity can be increased in the low voltage and high frequency region.

The thickness of each of the internal electrode layers 12 in the Z-axis direction can be measured by observing a cross section of the multilayer ceramic capacitor 100 including the Z-axis direction with a SEM (scanning electron microscope), measuring the thickness at 10 points for each of the different 10 internal electrode layers 12, and deriving the average value of all the measurement points. The thickness of each of the dielectric layers 11 in the Z-axis direction can be measured by observing a cross section of the multilayer ceramic capacitor 100 including the Z-axis direction with a SEM, measuring the thickness at 10 points for each of the different 10 dielectric layers 11, and deriving the average value of all the measurement points.

To increase the amount of shrinkage of the side margins 16 in the Z-axis direction, it is preferable to make the internal electrode layers 12 even thicker. In this embodiment, the thickness of the internal electrode layers 12 in the Z-axis direction is preferably 1.75 times or more, and more preferably 2 times or more, the thickness of each dielectric layer 11 in the Z-axis direction.

The thickness of each of the internal electrode layers 12 in the Z-axis direction is, for example, 0.20 μm or more and 0.90 μm or less, or 0.30 μm or more 0.80 μm or less, or 0.40 μm or more and 0.70 μm or less. The thickness of each of the dielectric layers 11 in the Z-axis direction is, for example, 0.1 μm or more and 0.7 μm or less, 0.2 μm or more and 0.6 μm or less, or 0.3 μm or more and 0.5 μm or less.

In addition, in the multilayer ceramic capacitor 100 according to this embodiment, the number of layers of the internal electrode layers 12 may be 400 or more, or 500 or more. When the number of layers of the internal electrode layers 12 is 300 or more, it is preferable that the multilayer ceramic capacitor 100 has a size of 0603 shape (length 0.6 mm, width 0.3 mm, height 0.3 mm) or more. As an example, when the total thickness of the dielectric layer 11 and the internal electrode layer 12 is 1 μm or more, a height of about 300 μm is required. When the number of layers of the internal electrode layers 12 is 500 or more, it is preferable that the multilayer ceramic capacitor 100 has a size of 1005 shape (length 1.0 mm, width 0.5 mm, height 0.5 mm) or more.

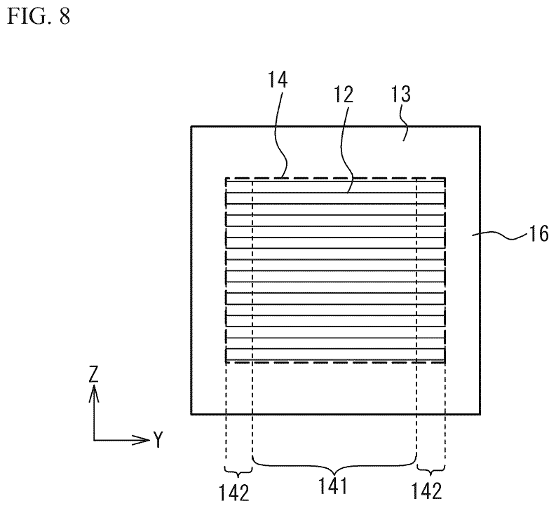

FIG. 8 is a diagram for explaining each region in the YZ cross section corresponding to the cross section of the line B-B in FIG. 1. As illustrated in FIG. 8, in the capacity section 14, a section of a predetermined range inside in the Y-axis direction is defined as an inner section 141. In the capacity section 14, two sections sandwiching the inner section 141 from the Y-axis direction are defined as outer sections 142. In this embodiment, when the dimension of the capacity section 14 in the Y-axis direction is 100%, each of the two outer sections 142 is a section of a range of 10%. Therefore, when the dimension of the capacity section 14 in the Y-axis direction is taken as 100%, the dimension of the inner section 141 in the Y-axis direction is the remaining 80% of the dimension.

In this embodiment, since it is preferable that the grain diameter of the ceramic grains 41 in the dielectric layer 11 is small, in the inner section 141, the D50% grain diameter of the grain size distribution of the ceramic grains 41 in the dielectric layer 11 is preferably 200 nm or less, more preferably 150 nm or less, and even more preferably 120 nm or less. In addition, since it is preferable that the grain diameter of the ceramic grains 41 in the dielectric layer 11 is uniform, in the inner section 141, the D90% grain diameter of the grain size distribution of the ceramic grains 41 in the dielectric layer 11 is preferably 300 nm or less, more preferably 250 nm or less, and even more preferably 200 nm or less.

If the grain diameter of the ceramic grains 41 in the dielectric layer 11 is too small, the dielectric constant will be too low, and there is a risk of insufficient capacity. Therefore, it is preferable to set a lower limit on the D50% grain diameter of the ceramic grains 41 in the dielectric layer 11 in the inner section 141. In this embodiment, the D50% grain diameter of the ceramic grains 41 in the dielectric layer 11 in the inner section 141 is preferably 50 nm or more, more preferably 80 nm or more, and even more preferably 100 nm or more.

The D50% grain diameter of the ceramic grains 41 of the dielectric layer 11 in the outer section 142 is preferably larger than the D50% grain diameter of the ceramic grains 41 of the dielectric layer 11 in the inner section 141. If the D50% grain diameter of the ceramic grains 41 in the outer section 142 is too small, the targeted electrostatic capacity (0 V) may not be necessarily obtained.

Here, a method for measuring the grain size distribution of the ceramic grains in the inner section 141, the outer section 142, and the side margin 16 will be described. At the center in the X-axis direction of the multilayer ceramic capacitor 100, the multilayer ceramic capacitor 100 is cut parallel to the end faces on which the external electrodes are formed, and the cross section is polished. This cross section corresponds to the YZ cross section. The grain diameter of the ceramic grains is measured based on a cross-sectional photograph of the dielectric layer taken of the cross section with a scanning electron microscope (SEM). Based on the SEM image, the maximum length of the ceramic grains in the stacking direction is taken as the grain diameter, and the grain size distribution is obtained. If the particle size distribution is obtained, the D50% grain diameter and the D90% grain diameter can be obtained.

In addition, in order to increase the amount of shrinkage in the Z-axis direction in the side margin 16, it is preferable to make the silicon concentration in the side margin 16 higher than that in the capacity section 14. When the main component of the dielectric layer 11 and the side margin 16 is barium titanate, the Si/Ti element number ratio can be substituted for the silicon concentration. Therefore, when the main component of the dielectric layer 11 and the side margin 16 is barium titanate, it is preferable that the Si/Ti element number ratio is higher in the side margin 16 than in the capacity section 14 (the inner section 141 and the outer section 142).

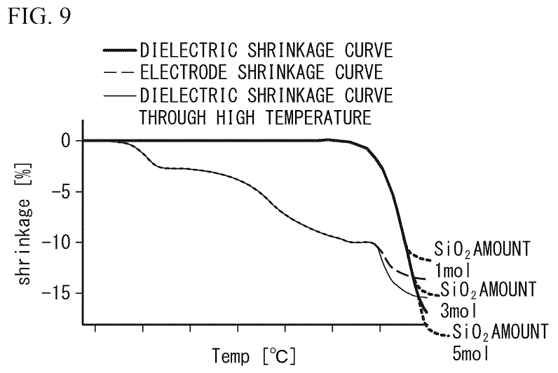

FIG. 9 is a diagram illustrating the relationship between the amount of silicon amount and the amount of shrinkage. In FIG. 9, the horizontal axis indicates temperature, and the vertical axis indicates the amount of shrinkage (%). The larger the absolute value of the negative value of the amount of shrinkage is, the larger the amount of shrinkage is. As illustrated in FIG. 9, the greater the amount of SiO₂ amount is, the greater the amount of shrinkage is.

In the side margin 16, the Si/Ti element number ratio is preferably 0.01 or more, more preferably 0.03 or more, and even more preferably 0.05 or more.

Furthermore, in order to increase the amount of shrinkage in the Z-axis direction in the end margin 15, it is preferable to make the silicon concentration in the end margin 15 higher than the silicon concentration in the capacity section 14. When the main component of the dielectric layer 11 and the end margin 15 is barium titanate, the Si/Ti element number ratio can be used as a substitute for the silicon concentration. Therefore, when the main component of the dielectric layer 11 and the end margin 15 is barium titanate, it is preferable that the Si/Ti element number ratio is higher in the end margin 15 than in the capacity section 14 (the inner section 141 and the outer section 142).

In the end margin 15, the Si/Ti element number ratio is preferably 0.01 or more, more preferably 0.03 or more, and even more preferably 0.05 or more.

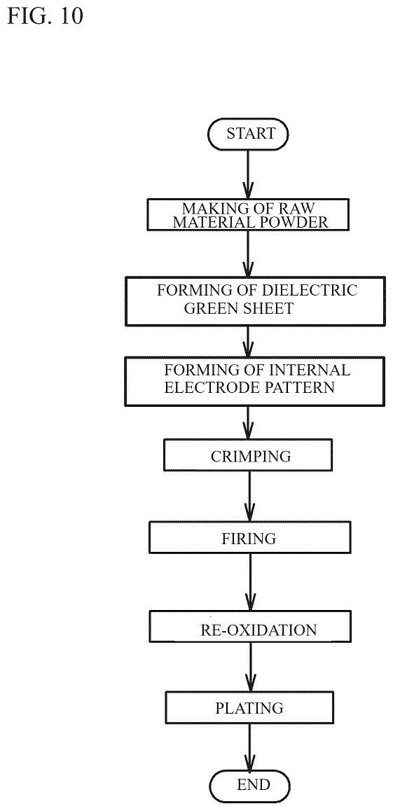

Next, a description will be given of a manufacturing method of the multilayer ceramic capacitors 100. FIG. 10 illustrates a manufacturing method of the multilayer ceramic capacitor 100.

(Making process of raw material powder) A dielectric material for forming the dielectric layer 11 is prepared. An A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate.

A predetermined additive compound is added to the obtained dielectric powder according to the purpose. As additives to the dielectric layer 11, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric material is obtained.

(Forming process of dielectric green sheet) Next, a binder such as polyvinyl butyral (PVB) resin, an organic solvent such as ethanol or toluene, and a plasticizer are added to the obtained dielectric material and wet-mixed. Using the obtained slurry, a dielectric green sheet 51 is formed on the substrate by, for example, a die coater method or a doctor blade method, and dried. The substrate is, for example, polyethylene terephthalate (PET) film. The process is not illustrated.

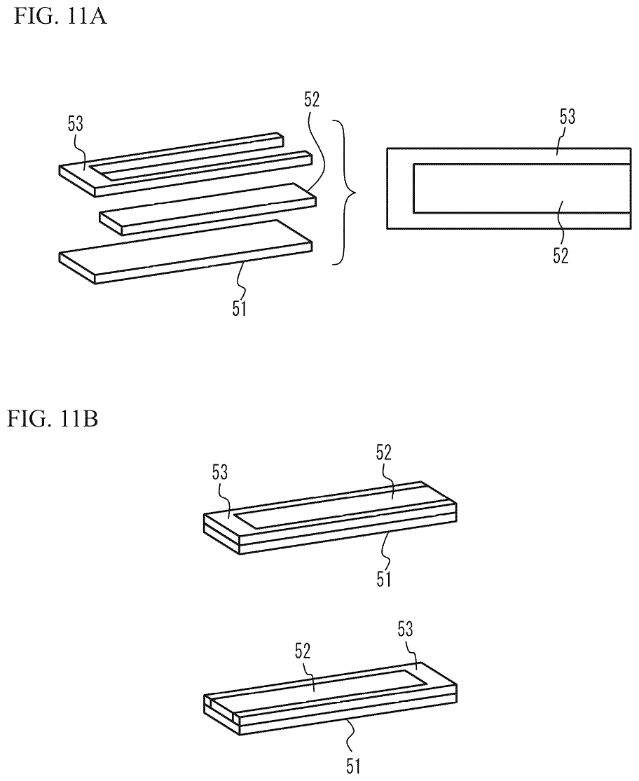

(Forming process of internal electrode pattern) Next, as illustrated in FIG. 11A, a metal conductive paste for forming internal electrodes containing an organic binder is printed on the surface of the dielectric green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11. The thickness of the internal electrode pattern 52 is adjusted so that the thickness of the internal electrode layer 12 obtained by firing the metal conductive paste is 1.5 times or more the thickness of the dielectric layer 11 obtained by firing the dielectric green sheet 51.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 11A, a dielectric pattern 53 is formed by printing the resulting slurry in the peripheral region, where the internal electrode pattern 52 is not printed, on the dielectric green sheet 51 to cause the dielectric pattern 53 and the internal electrode pattern 52 to form a flat surface. The dielectric green sheet 51 on which the internal electrode pattern 52 and the dielectric pattern 53 are printed is referred to as a stack unit. In this embodiment, it is preferable that the silicon concentration in the main component ceramic is higher in the dielectric pattern 53 than in the dielectric green sheet 51.

Thereafter, as illustrated in FIG. 11B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 300 or more.

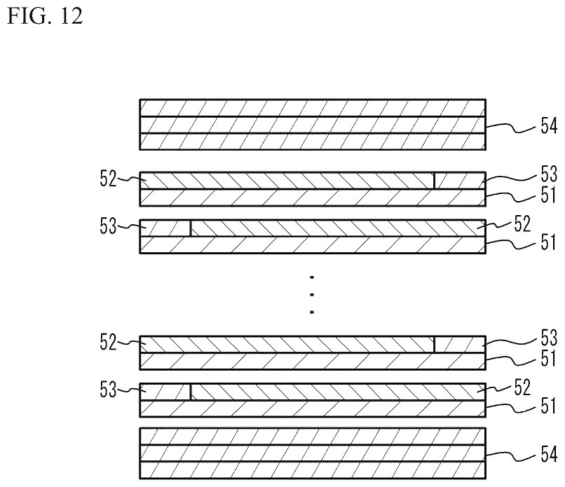

(Crimping process) As illustrated in FIG. 12, a predetermined number (for example, 2 to 10) cover sheets 54 are stacked on the stacked stack units and under the stacked stack units. After that, the stacked structure is thermally crimped. The cover sheet 54 is also a green sheet including a ceramic powder.

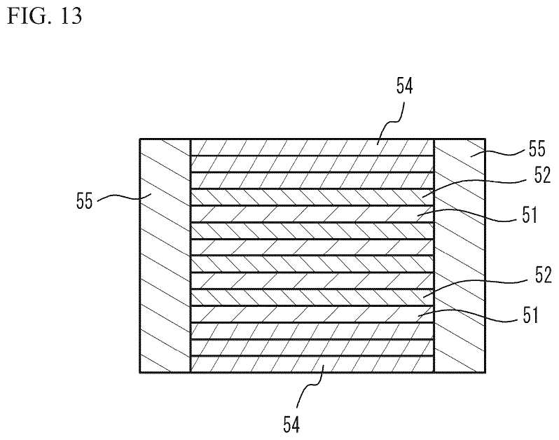

The side margins may be attached or applied to the side surfaces of the multilayer portion. Specifically, as illustrated in FIG. 13, the multilayer portion is obtained by alternately stacking the dielectric green sheets 51 and the internal electrode patterns 52 of the same width as the dielectric green sheets 51. Next, a sheet formed from a dielectric pattern paste may be attached to the side surface of the laminated portion as side margins 55. In this embodiment, it is preferable to make the silicon concentration in the main component ceramic higher in the side margins 55 than in the dielectric green sheets 51.

(Firing process) The binder is removed from the resulting ceramic multilayer structure in N₂ atmosphere. After that, a metal paste to be the base layer of the external electrodes 20a and 20b is applied to the resulting ceramic multilayer by a dipping or the like. A firing is performed for 5 minutes to 10 hours in a reducing atmosphere with an oxygen partial pressure of 10⁻¹² to 10⁻⁹ MPa in a temperature of 1160° C. to 1280° C. (for example, 1180° C. or more and 1230° C. or less).

(Re-oxidation process) In order to return oxygen to the partially reduced main phase barium titanate of the dielectric layer 11 fired in a reducing atmosphere, N₂ and water vapor are mixed at about 1000° C. to an extent that the internal electrode layer 12 is not oxidized, heat treatment may be performed in gas or in the atmosphere at 500° C. to 700° C. This process is called a re-oxidation process.

(Plating process) After that, metal layers such as copper, nickel, and tin may be formed on the external electrodes 20a and 20b by plating. Thus, the multilayer ceramic capacitor 100 is manufactured.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### Example

The multilayer ceramic capacitors according to the above embodiment were fabricated and their characteristics were examined.

(Examples 1-6 and Comparative Examples 1-6) Barium titanate powder was prepared as ceramic raw material powder. The average diameter of the ceramic raw material powder was set to 100 nm. The ceramic raw material powder was then wet mixed with an organic solvent. A binder was added to obtain a slurry, which was then applied to a dielectric green sheet by the doctor blade method and dried. An internal electrode pattern was formed by screen printing a metal conductive paste containing Ni in a predetermined pattern on the dielectric green sheet. In addition, in order to fill the step between the dielectric green sheet and the internal electrode pattern, a dielectric pattern having a pattern complementary to the internal electrode pattern was screen printed on the dielectric green sheet. The obtained stack units were stacked, pressed, and cut to obtain a compact.

The compact sample was de-bindered at a temperature of 300° C. in an N₂ atmosphere. It was then fired at a temperature range of 1300° C. to 1250° C. in a reducing atmosphere with an oxygen partial pressure of 10⁻⁵ atm to 10⁻⁸ atm. After cooling, the temperature was raised to a temperature range of 800° C. to 1050° C. in an N₂ atmosphere, and the temperature was maintained for re-oxidation.

In all of Examples 1 to 6 and Comparative Examples 1 to 6, the size of the obtained samples was 0603 shape (length 0.6 mm, width 0.3 mm, height 0.3 mm). In Comparative Examples 1 to 3, the number of stack units was 200. In Examples 1 and 2 and Comparative Example 4, the number of stack units was 300. In Examples 3 and 4 and Comparative Example 5, the number of stack units was 400. In Examples 5 and 6 and Comparative Example 6, the number of stack units was 500.

In all of Examples 1 to 6 and Comparative Examples 1 to 6, the thickness of each dielectric layer in the sample after firing was 0.40 μm. In Comparative Example 1 and Examples 1, 3, and 5, the thickness of each internal electrode layer was 0.70 μm. In Comparative Example 2 and Examples 2, 4, and 6, the thickness of each internal electrode layer was 0.60 μm. In Comparative Examples 3 to 6, the thickness of each internal electrode layer was 0.50 μm.

The D50% grain diameter of the ceramic grains in the inner section 141 described in FIG. 8 was 149 nm in Comparative Example 1, 152 nm in Comparative Example 2, 161 nm in Comparative Example 3, 148 nm in Example 1, 157 nm in Example 2, 164 nm in Comparative Example 4, 152 nm in Example 3, 161 nm in Example 4, 171 nm in Comparative Example 5, 155 nm in Example 5, 163 nm in Example 6, and 174 nm in Comparative Example 6.

The D50% grain diameter of the ceramic grains in the outer section 142 described in FIG. 8 was 171 nm in Comparative Example 1, 183 nm in Comparative Example 2, 198 nm in Comparative Example 3, 182 nm in Example 1, 191 nm in Example 2, 209 nm in Comparative Example 4, 187 nm in Example 3, 193 nm in Example 4, 217 nm in Comparative Example 5, 191 nm in Example 5, 197 nm in Example 6, and 223 nm in Comparative Example 6.

The Si/Ti element number ratio in the inner section 141 described in FIG. 8 was 0.007 in Comparative Example 1, 0.007 in Comparative Example 2, 0.007 in Comparative Example 3, 0.008 in Example 1, 0.007 in Example 2, 0.007 in Comparative Example 4, 0.007 in Example 3, 0.008 in Example 4, 0.007 in Comparative Example 5, 0.007 in Example 5, 0.007 in Example 6, and 0.007 in Comparative Example 6.

The Si/Ti element number ratio in the outer section 142 described in FIG. 8 was 0.007 in Comparative Example 1, 0.007 in Comparative Example 2, 0.007 in Comparative Example 3, 0.007 in Example 1, 0.007 in Example 2, 0.008 in Comparative Example 4, 0.007 in Example 3, 0.007 in Example 4, 0.007 in Comparative Example 5, 0.008 in Example 5, 0.007 in Example 6, and 0.007 in Comparative Example 6.

The Si/Ti element number ratio in the side margin 16 was 0.035 in Comparative Example 1, 0.036 in Comparative Example 2, 0.034 in Comparative Example 3, 0.036 in Example 1, 0.035 in Example 2, 0.035 in Comparative Example 4, 0.034 in Example 3, 0.035 in Example 4, 0.035 in Comparative Example 5, 0.034 in Example 5, 0.036 in Example 6, and 0.035 in Comparative Example 6.

The Si/Ti element number ratio in the end margin 15 was 0.007 in Comparative Example 1, 0.007 in Comparative Example 2, 0.007 in Comparative Example 3, 0.008 in Example 1, 0.007 in Example 2, 0.007 in Comparative Example 4, 0.007 in Example 3, 0.008 in Example 4, 0.008 in Comparative Example 5, 0.007 in Example 5, 0.007 in Example 6, and 0.007 in Comparative Example 6.

The above results are shown in Table 1. SM indicates the side margin, and EM indicates the end margin.

TABLE 1

| | | THICK- | | | | | | | | | | |
|---|---|---|---|---|---|---|---|---|---|---|---|---|
| | | NESS | THICK- | | | | | | | | | |
| | | OF | NESS | D50% | | | | | | | CAPAC- | CAPAC- |
| | NUM- | INTER- | OF | GRAIN | | | | | | CAPAC- | ITY | ITY |
| | BER | NAL | DI- | DIAMETER | | Si/Ti | | | | ITY | @10 | CHANGE |
| | OF | ELEC- | ELECTRIC | (nm) | | ELEMENT NUMBER RATIO | | | | @10 | mVrms- | CRATE |
| | STACK | TRODE | LAYER | INNER | OUTER | INNER | OUTER | | | mVrms | 1V Bias | @1V Bias |
| | UNIT | (μm) | (μm) | SECTION | SECTION | SECTION | SECTION | SM | EM | (μF) | (μF) | (%) |
| COM- | 200 | 0.70 | 0.40 | 149 | 171 | 0.007 | 0.007 | 0.035 | 0.007 | 1.13 | 1.01 | −14 |
| PARATIVE | | | | | | | | | | | | |
| EXAMPLE 1 | | | | | | | | | | | | |
| COM- | | 0.60 | | 152 | 183 | 0.007 | 0.007 | 0.036 | 0.007 | 1.24 | 1.03 | −17 |
| PARATIVE | | | | | | | | | | | | |
| EXAMPLE 2 | | | | | | | | | | | | |
| COM- | | 0.50 | | 161 | 198 | 0.007 | 0.007 | 0.034 | 0.007 | 1.13 | 0.92 | −19 |
| PARATIVE | | | | | | | | | | | | |
| EXAMPLE 3 | | | | | | | | | | | | |
| EXAMPLE 1 | 300 | 0.70 | 0.40 | 148 | 182 | 0.008 | 0.007 | 0.036 | 0.008 | 1.81 | 1.58 | −16 |
| EXAMPLE 2 | | 0.60 | | 157 | 191 | 0.007 | 0.007 | 0.035 | 0.007 | 1.91 | 1.59 | −17 |
| COM- | | 0.50 | | 164 | 209 | 0.007 | 0.008 | 0.035 | 0.007 | 1.76 | 1.39 | −21 |
| PARATIVE | | | | | | | | | | | | |
| EXAMPLE 4 | | | | | | | | | | | | |
| EXAMPLE 3 | 400 | 0.70 | 0.40 | 152 | 187 | 0.007 | 0.007 | 0.034 | 0.007 | 2.47 | 2.16 | −16 |
| EXAMPLE 4 | | 0.60 | | 161 | 193 | 0.008 | 0.007 | 0.035 | 0.008 | 2.59 | 2.12 | −18 |
| COM- | | 0.50 | | 171 | 217 | 0.007 | 0.007 | 0.035 | 0.008 | 2.39 | 1.84 | −23 |
| PARATIVE | | | | | | | | | | | | |
| EXAMPLE 5 | | | | | | | | | | | | |
| EXAMPLE 5 | 500 | 0.70 | 0.40 | 155 | 191 | 0.007 | 0.008 | 0.034 | 0.007 | 3.16 | 2.73 | −17 |
| EXAMPLE 6 | | 0.60 | | 163 | 197 | 0.007 | 0.007 | 0.036 | 0.007 | 3.31 | 2.68 | −19 |
| COM- | | 0.50 | | 174 | 223 | 0.007 | 0.007 | 0.035 | 0.007 | 3.07 | 2.33 | −24 |
| PARATIVE | | | | | | | | | | | | |
| EXAMPLE 6 | | | | | | | | | | | | |

The electrostatic capacity was measured for each sample of Examples 1 to 6 and Comparative Examples 1 to 6. An LCR meter 4284A was used for the measurement. As a pretreatment, each sample was heat-reconditioned at 150° C. for 1 hour and left for 24 hours. In Table 1, electrostatic capacity @ 10 mVrms (μF) is the electrostatic capacity when 100 kHz AC is applied at 0.01 V. In Table 1, electrostatic capacity @ 10 mVrms-1VBias is the electrostatic capacity when a bias voltage of DC 1 Vis applied and 100 kHz AC is applied at 0.01 V. The electrostatic capacity change rate @ 1VBias indicates the rate of decrease from electrostatic capacity @ 10 mVrms to electrostatic capacity @ 10 mVrms-1VBias.

As shown in Table 1, in Comparative Examples 1 to 3, the electrostatic capacity @10 mVrms was not sufficiently high. This is believed to be because the number of stack units was small. Next, for Examples 1 and 2 and Comparative Example 4, which had 300 stack units, the electrostatic capacity change rate @1 VBias was improved in Examples 1 and 2 compared to Comparative Example 4. This is believed to be because the thickness of the internal electrode layer was set to 1.5 times or more the thickness of the dielectric layer in Examples 1 and 2. Next, for Examples 3 and 4 and Comparative Example 5, which had 400 stack units, the electrostatic capacity change rate @1 VBias was improved in Examples 3 and 4 compared to Comparative Example 5. This is believed to be because the thickness of the internal electrode layer was set to 1.5 times or more the thickness of the dielectric layer in Examples 3 and 4. Next, for Examples 5 and 6 and Comparative Example 6, which had 500 stack units, the electrostatic capacity change rate @1 VBias was improved in Examples 5 and 6 compared to Comparative Example 6. This is believed to be because in Examples 5 and 6, the thickness of the internal electrode layer was 1.5 times or more the thickness of the dielectric layer.

(Examples 7-13) In Examples 7-13, samples were produced in the same manner as in Example 1. In all of Examples 7-14, the size of the obtained samples was 0603 shape (length 0.6 mm, width 0.3 mm, height 0.3 mm). The number of stack units was 400. The thickness of each dielectric layer in the sample after firing was 0.40 μm. The thickness of each internal electrode layer in the sample after firing was 0.60 μm.

The D50% grain diameter of the ceramic grains in the inner section 141 described in FIG. 8 was 161 nm in Example 7, 163 nm in Example 8, 162 nm in Example 9, 161 nm in Example 10, 161 nm in Example 11, 161 nm in Example 12, and 161 nm in Example 13.

The D50% grain diameter of the ceramic grains in the outer section 142 described in FIG. 8 was 193 nm in Example 7, 194 nm in Example 8, 198 nm in Example 9, 192 nm in Example 10, 194 nm in Example 11, 191 nm in Example 12, and 193 nm in Example 13.

The Si/Ti element number ratio in the inner section 141 described in FIG. 8 was 0.008 in Example 7, 0.008 in Example 8, 0.007 in Example 9, 0.008 in Example 10, 0.008 in Example 11, 0.008 in Example 12, and 0.008 in Example 13.

The Si/Ti element number ratio in the outer section 142 described in FIG. 8 was 0.007 in Example 7, 0.007 in Example 8, 0.007 in Example 9, 0.007 in Example 10, 0.007 in Example 11, 0.007 in Example 12, and 0.007 in Example 13.

The Si/Ti element number ratio in the side margin was 0.035 in Example 7, 0.025 in Example 8, 0.015 in Example 9, 0.035 in Example 10, 0.035 in Example 11, 0.035 in Example 12, and 0.035 in Example 13.

The Si/Ti element number ratio in the end margin was 0.008 in Example 7, 0.008 in Example 8, 0.007 in Example 9, 0.035 in Example 10, 0.026 in Example 11, 0.014 in Example 12, and 0.008 in Example 13.

The above results are shown in Table 2. SM indicates the side margin, and EM indicates the end margin.

TABLE 2

| | | THICK- | THICK- | | | | | | | | | |
|---|---|---|---|---|---|---|---|---|---|---|---|---|
| | | NESS | NESS | | | | | | | | | |
| | | OF | OF | D50% | | | | | | | CAPAC- | CAPAC- |
| | NUM- | INTER- | DI- | GRAIN | | | | | | CAPAC- | ITY | ITY |
| | BER | NAL | ELEC- | DIAMETER | | Si/Ti | | | | ITY | @10 | CHANGE |
| | OF | ELEC- | TRIC | (nm) | | ELEMENT NUMBER RATIO | | | | @10 | mVrms- | CRATE |
| | STACK | TRODE | LAYER | INNER | OUTER | INNER | OUTER | | | mVrms | 1V Bias | @1V Bias |
| | UNIT | (μm) | (μm) | SECTION | SECTION | SECTION | SECTION | SM | EM | (μF) | (μF) | (%) |
| EXAMPLE 7 | 400 | 0.80 | 0.40 | 161 | 193 | 0.008 | 0.007 | 0.035 | 0.008 | 2.59 | 2.12 | −18 |
| EXAMPLE 8 | | | | 163 | 194 | 0.008 | 0.007 | 0.025 | 0.008 | 2.61 | 2.23 | −18 |
| EXAMPLE 9 | | | | 162 | 198 | 0.007 | 0.007 | 0.015 | 0.007 | 2.61 | 2.20 | −19 |
| EXAMPLE 10 | | | | 161 | 192 | 0.008 | 0.007 | 0.035 | 0.035 | 2.54 | 2.16 | −15 |
| EXAMPLE 11 | | | | 161 | 194 | 0.008 | 0.007 | 0.035 | 0.026 | 2.57 | 2.13 | −17 |
| EXAMPLE 12 | | | | 161 | 191 | 0.008 | 0.007 | 0.035 | 0.014 | 2.58 | 2.14 | −17 |
| EXAMPLE 13 | | | | 161 | 193 | 0.008 | 0.007 | 0.035 | 0.008 | 2.59 | 2.12 | −18 |

The electrostatic capacity of each sample of Examples 7 to 13 was measured using the same method as in Example 1. As shown in Table 2, it was confirmed that a good electrostatic capacity change rate @1 VBias can be obtained by increasing the Si/Ti element number ratio in at least one of the side margin and the end margin compared to the inner section and the outer section.

(Examples 14 to 19 and Comparative Examples 7 to 9) Samples were produced using the same method as in Example 1. In all of Examples 14 to 19 and Comparative Examples 7 to 9, the size of the obtained samples was 1005 shape (length 1.0 mm, width 0.5 mm, height 0.5 mm). In Examples 14, 15 and Comparative Example 7, the number of stack units was 300. In Examples 16, 17 and Comparative Example 8, the number of stack units was 400. In Examples 18 and 19 and Comparative Example 9, the number of stack units was 500.

In all of Examples 14 to 19 and Comparative Examples 7 to 9, the thickness of each dielectric layer in the fired sample was 0.40 μm. In Examples 14, 16, and 18, the thickness of each internal electrode layer was 0.70 μm. In Examples 15, 17, and 19, the thickness of each internal electrode layer was 0.60 μm. In Comparative Examples 7 to 9, the thickness of each internal electrode layer was 0.50 μm.

The D50% grain diameter of the ceramic grains in the inner section 141 described in FIG. 8 was 146 nm in Example 14, 148 nm in Example 15, 161 nm in Comparative Example 7, 150 nm in Example 16, 155 nm in Example 17, 168 nm in Comparative Example 8, 145 nm in Example 18, 151 nm in Example 19, and 172 nm in Comparative Example 9.

The D50% grain diameter of the ceramic grains in the outer section 142 described in FIG. 8 was 157 nm in Example 14, 162 nm in Example 15, 185 nm in Comparative Example 7, 161 nm in Example 16, 175 nm in Example 17, 193 nm in Comparative Example 8, 156 nm in Example 18, 169 nm in Example 19, and 198 nm in Comparative Example 9.

The Si/Ti element ratio in the inner section 141 described in FIG. 8 was 0.007 in Example 14, 0.008 in Example 15, 0.007 in Comparative Example 7, 0.008 in Example 16, 0.007 in Example 17, 0.008 in Comparative Example 8, 0.007 in Example 18, 0.008 in Example 19, and 0.007 in Comparative Example 9.

The Si/Ti element number ratio in the outer section 142 described in FIG. 8 was 0.007 in Example 14, 0.007 in Example 15, 0.008 in Comparative Example 7, 0.007 in Example 16, 0.007 in Example 17, 0.007 in Comparative Example 8, 0.007 in Example 18, 0.008 in Example 19, and 0.008 in Comparative Example 9.

The Si/Ti element number ratio in the side margin 16 was 0.036 in Example 14, 0.034 in Example 15, 0.036 in Comparative Example 7, 0.036 in Example 16, 0.035 in Example 17, 0.036 in Comparative Example 8, 0.036 in Example 18, 0.035 in Example 19, and 0.034 in Comparative Example 9.

The Si/Ti element number ratio in the end margin 15 was 0.008 in Example 14, 0.007 in Example 15, 0.007 in Comparative Example 7, 0.007 in Example 16, 0.008 in Example 17, 0.008 in Comparative Example 8, 0.007 in Example 18, 0.007 in Example 19, and 0.007 in Comparative Example 9.

The above results are shown in Table 3. SM indicates the side margin, and EM indicates the end margin.

TABLE 3

| | | THICK- | THICK- | | | | | | | | | |
|---|---|---|---|---|---|---|---|---|---|---|---|---|
| | | NESS | NESS | D50% | | | | | | | CAPAC- | CAPAC- |
| | NUM- | OF IN- | OF DI- | GRAIN | | | | | | CAPAC- | ITY | ITY |
| | BER | TERNAL | ELEC- | DIAMETER | | Si/Ti | | | | ITY | @10 | CHANGE |
| | OF | ELEC- | TRIC | (nm) | | ELEMENT NUMBER RATIO | | | | @10 | mVrms- | CRATE |
| | STACK | TRODE | LAYER | INNER | OUTER | INNER | OUTER | | | mVms | 1V Bias | @1V Bias |
| | UNIT | (μm) | (μm) | SECTION | SECTION | SECTION | SECTION | SM | EM | (μF) | (μF) | (%) |
| EXAMPLE 14 | 300 | 0.70 | 0.40 | 146 | 157 | 0.007 | 0.007 | 0.036 | 0.008 | 5.51 | 4.68 | −15 |
| EXAMPLE 15 | | 0.60 | | 148 | 162 | 0.008 | 0.007 | 0.034 | 0.007 | 5.81 | 4.88 | −16 |
| COMPARATIVE | | 0.50 | | 161 | 185 | 0.007 | 0.008 | 0.036 | 0.007 | 5.97 | 4.77 | −20 |
| EXAMPLE 7 | | | | | | | | | | | | |
| EXAMPLE 16 | 400 | 0.70 | 0.40 | 150 | 161 | 0.008 | 0.007 | 0.036 | 0.007 | 7.96 | 6.68 | −16 |
| EXAMPLE 17 | | 0.60 | | 155 | 175 | 0.007 | 0.007 | 0.035 | 0.008 | 8.16 | 6.69 | −18 |
| COMPARATIVE | | 0.50 | | 168 | 193 | 0.008 | 0.007 | 0.036 | 0.008 | 8.36 | 6.44 | −23 |
| EXAMPLE 8 | | | | | | | | | | | | |
| EXAMPLE 18 | 500 | 0.70 | 0.40 | 145 | 156 | 0.007 | 0.007 | 0.036 | 0.007 | 12.24 | 10.40 | −15 |
| EXAMPLE 19 | | 0.60 | | 151 | 169 | 0.008 | 0.008 | 0.035 | 0.007 | 12.55 | 10.41 | −17 |
| COMPARATIVE | | 0.50 | | 172 | 198 | 0.007 | 0.008 | 0.034 | 0.007 | 13.16 | 10.00 | −24 |
| EXAMPLE 9 | | | | | | | | | | | | |

For Examples 14 and 15 and Comparative Example 7, which have 300 stack units, the electrostatic capacity change rate @1 VBias was improved in Examples 14 and 15 compared to Comparative Example 7. This is thought to be because in Examples 14 and 15, the thickness of the internal electrode layer was made 1.5 times or more the thickness of the dielectric layer. Next, for Examples 16 and 17 and Comparative Example 8, which have 400 stack units, the electrostatic capacity change rate @1VBias was improved in Examples 16 and 17 compared to Comparative Example 8. This is believed to be because the thickness of the internal electrode layer was set to 1.5 times or more the thickness of the dielectric layer in Examples 16 and 17. Next, for Examples 18 and 19 and Comparative Example 9, which have 500 stack units, the electrostatic capacity change rate @1 VBias was improved in Examples 18 and 19 compared to Comparative Example 9. This is believed to be because the thickness of the internal electrode layer was set to 1.5 times or more the thickness of the dielectric layer in Examples 18 and 19.

(Examples 20 to 29) In Examples 20 to 29, samples were prepared in the same manner as in Example 1. In all of Examples 20 to 29, the size of the obtained sample was 1005 shape (length 1.0 mm, width 0.5 mm, height 0.5 mm). The number of stack units was 600. The thickness of each dielectric layer in the fired sample was 0.40 μm. The thickness of each internal electrode layer in the fired sample was 0.60 μm.

The D50% grain size of the ceramic grains in the inner section 141 described in FIG. 8 was 151 nm in Example 20, 152 nm in Example 21, 156 nm in Example 22, 146 nm in Example 23, 148 nm in Example 24, 149 nm in Example 25, 151 nm in Example 26, 149 nm in Example 27, 146 nm in Example 28, and 161 nm in Example 29.

The D50% grain diameter size of the ceramic grains in the outer section 142 described in FIG. 8 was 169 nm in Example 20, 170 nm in Example 21, 176 nm in Example 22, 155 nm in Example 23, 159 nm in Example 24, 158 nm in Example 25, 169 nm in Example 26, 161 nm in Example 27, 151 nm in Example 28, and 177 nm in Example 29.

The Si/Ti element number ratio in the inner section 141 described in FIG. 8 was 0.008 in Example 20, 0.008 in Example 21, 0.007 in Example 22, 0.008 in Example 23, 0.008 in Example 24, 0.008 in Example 25, 0.008 in Example 26, 0.015 in Example 27, 0.025 in Example 28, and 0.003 in Example 29.

The Si/Ti element number ratio in the outer section 142 described in FIG. 8 was 0.008 in Example 20, 0.007 in Example 21, 0.007 in Example 22, 0.007 in Example 23, 0.007 in Example 24, 0.007 in Example 25, 0.007 in Example 26, 0.015 in Example 27, 0.025 in Example 28, and 0.003 in Example 29.

The Si/Ti element number ratio in the side margin was 0.035 in Example 20, 0.025 in Example 21, 0.015 in Example 22, 0.035 in Example 23, 0.035 in Example 24, 0.035 in Example 25, 0.035 in Example 26, 0.035 in Example 27, 0.035 in Example 28, and 0.0035 in Example 29.

The Si/Ti element number ratio in the end margin was 0.007 in Example 20, 0.008 in Example 21, 0.007 in Example 22, 0.035 in Example 23, 0.026 in Example 24, 0.014 in Example 25, 0.007 in Example 26, 0.007 in Example 27, 0.007 in Example 28, and 0.007 in Example 29.

The above results are shown in Table 4. SM indicates the side margin, and EM indicates the end margin.

TABLE 4

| | | THICK- | THICK- | | | | | | | | CAPAC- | |
|---|---|---|---|---|---|---|---|---|---|---|---|---|
| | | NESS | NESS | D50% | | | | | | CAPAC- | ITY | CAPAC- |
| | NUM- | OF IN- | OF DI- | GRAIN | | | | | | ITY | CHANGE | ITY |
| | BER | TERNAL | ELEC- | DIAMETER | | Si/Ti | | | | @10 | CRATE | @10 |
| | OF | ELEC- | TRIC | (nm) | | ELEMENT NUMBER RATIO | | | | mVrms- | @1V | mVrms- |
| | STACK | TRODE | LAYER | INNER | OUTER | INNER | OUTER | | | 1V Bias | Bias | 1V Bias |
| | UNIT | (μm) | (μm) | SECTION | SECTION | SECTION | SECTION | SM | EM | (μF) | (%) | (μF) |
| EXAM- | 600 | 0.60 | 0.40 | 151 | 169 | 0.008 | 0.008 | 0.035 | 0.007 | 12.55 | 10.41 | −37 |
| PLE 20 | | | | | | | | | | | | |
| EXAM- | | | | 152 | 170 | 0.008 | 0.007 | 0.025 | 0.008 | 12.67 | 10.51 | −17 |
| PLE 21 | | | | | | | | | | | | |
| EXAM- | | | | 156 | 176 | 0.007 | 0.007 | 0.015 | 0.007 | 12.73 | 10.44 | −18 |
| PLE 22 | | | | | | | | | | | | |
| EXAM- | | | | 146 | 155 | 0.008 | 0.007 | 0.035 | 0.035 | 12.30 | 10.46 | −15 |
| PLE 23 | | | | | | | | | | | | |
| EXAM- | | | | 148 | 159 | 0.008 | 0.007 | 0.035 | 0.026 | 12.42 | 10.44 | −16 |
| PLE 24 | | | | | | | | | | | | |
| EXAM- | | | | 149 | 158 | 0.008 | 0.007 | 0.035 | 0.014 | 12.48 | 10.49 | −16 |
| PLE 25 | | | | | | | | | | | | |
| EXAM- | | | | 151 | 169 | 0.008 | 0.007 | 0.035 | 0.007 | 12.55 | 10.41 | −17 |
| PLE 26 | | | | | | | | | | | | |
| EXAM- | | | | 149 | 161 | 0.015 | 0.015 | 0.035 | 0.007 | 12.12 | 10.18 | −16 |
| PLE 27 | | | | | | | | | | | | |
| EXAM- | | | | 146 | 151 | 0.025 | 0.025 | 0.035 | 0.007 | 11.69 | 10.05 | −14 |
| PLE 28 | | | | | | | | | | | | |
| EXAM- | | | | 161 | 177 | 0.003 | 0.003 | 0.0035 | 0.007 | 12.79 | 10.36 | −19 |
| PLE 29 | | | | | | | | | | | | |

The electrostatic capacity of each sample of Examples 20 to 29 was measured using the same method as in Example 1. As shown in Table 4, it was confirmed that a good electrostatic capacity change rate @1 VBias can be obtained by making the Si/Ti element number ratio larger in at least one of the side margin and end margin than in the inner section and outer section.

Although the embodiments of the present invention have been described in detail, it is to be understood that the various change, substitutions, and alterations could be made hereto without departing from the spirit and scope of the invention.

What is claimed is:

1. A ceramic electronic device comprising:
a multilayer chip including a multilayer portion in which each of a plurality of dielectric layers and each of a plurality of internal electrode layers are alternately stacked,
wherein each of the plurality of internal electrode layers is alternately extracted to two end faces of the multilayer chip opposite to each other,
wherein the multilayer chip includes side margins outside of a capacity section in a third direction which is orthogonal to a first direction in which the plurality of internal electrode layers face each other and a second direction in which the two end faces are opposite to each other, the capacity section being a section in which the plurality of internal electrode layers face each other,
wherein a number of the plurality of internal electrode layers is 300 or more, and
wherein a thickness of one of the plurality of internal electrode layers is 1.5 times a thickness of one of the plurality of dielectric layers or more.

2. The ceramic electronic device as claimed in claim 1,
wherein each of thicknesses of the plurality of internal electrode layers is 1.5 times each of thicknesses of the plurality of dielectric layers or more.

3. The ceramic electronic device as claimed in claim 1,
wherein, in the plurality of dielectric layers, when each outer 10% of the capacity section in the third direction is defined as an outer section and a remaining inner 80% of the capacity section is defined as an inner section, a D50% grain diameter of a ceramic grain size distribution in the outer section is larger than a D50% grain diameter of a ceramic grain size distribution in the inner section.

4. The ceramic electronic device as claimed in claim 1,
wherein, in the plurality of dielectric layers, when each outer 10% of the capacity section in the third direction is defined as an outer section and a remaining inner 80% of the capacity section is defined as an inner section, a D50% grain diameter of a ceramic grain size distribution in the inner section is 50 nm or more and 200 nm or less.

5. The ceramic electronic device as claimed in claim 1,
wherein, in the plurality of dielectric layers, when each outer 10% of the capacity section in the third direction is defined as an outer section and a remaining inner 80% of the capacity section is defined as an inner section, a D90% grain diameter of a ceramic grain size distribution in the inner section is 300 nm or less.

6. The ceramic electronic device as claimed in claim 1,
wherein a Si/Ti element number ratio of the side margins is larger than a Si/Ti element number ratio of the plurality of dielectric layers.

7. The ceramic electronic device as claimed in claim 5,
wherein a Si/Ti element number of the side margins is 0.01 or more.

8. The ceramic electronic device as claimed in claim 1,
wherein end margins are sections that are located outside of the capacity section of the multilayer chip in the second direction, and in which internal electrode layers that are drawn to one of the two end faces face each other without interposing therebetween an internal electrode layer that is drawn to other end face, and
wherein a Si/Ti element number ratio of the end margins is larger than a Si/Ti element number ratio of the plurality of dielectric layers in the capacity section.

9. The ceramic electronic device as claimed in claim 7,
wherein a Si/Ti element number ratio of the end margins is 0.01 or more.

10. The ceramic electronic device as claimed in claim 1,
wherein the ceramic electronic device has a size of 0603 shape, in which a length is 0.6 mm, a width is 0.3 mm, and a height is 0.3 mm, or more.

11. The ceramic electronic device as claimed in claim 1,
wherein a number of the plurality of internal electrode layers is 500 or more, and
wherein the ceramic electronic device has a size of 100 shape, in which a length is 1.0 mm, a width is 0.5 mm, and as height is 0.5 mm, or more.

12. The ceramic electronic device as claimed in claim 5, wherein a Si/Ti element number ratio of the side margins is 0.03 or more.

13. The ceramic electronic device as claimed in claim 7, wherein a Si/Ti element number ratio of the end margins is 0.03 or more.
